(19) United States
(12) Patent Application Publication
(10) Pub. No.: US 2016/0028672 A1
(43) Pub. Date: Jan. 28, 2016

(54) Message Controlled Application and Operating System Image Development and Deployment

(71) Applicant: Polycom, Inc., San Jose, CA (US)

(72) Inventors: Amit Kaul, Bangalore (IN); Santhoskumar Settipalli, Karnataka (IN)

(21) Appl. No.: 14/804,112

(22) Filed: Jul. 20, 2015

(30) Foreign Application Priority Data
Jul. 22, 2014 (IN) 786/KOL/2014

(51) Int. Cl. H04L 12/58

(52) U.S. Cl. CPC H04L 51/10

(57) ABSTRACT

A highly automated development of cloud-based application image development and deployment. A developer user interface front end receives build requests and information for the developer. Alternatively, a code-checkin can also trigger a build request. The front end provides a message to a messaging system which is accessed by the other servers. A continuous integration server obtains the message and performs relevant steps in building the request application image, with a template server and the source code control server providing relevant files. As various tasks in developing the application image are completed, messages are sent to the messaging server. Other operations on the integration server listen for selected messages to initiate the next step in the process. Further, other servers monitor the messaging to perform relevant operations, such as storing files that have been produced. Ultimately the finished image can be deployed to application servers to allow user to operate the new application version.

### RELATED APPLICATIONS

This application claims priority under 35 U.S.C. §119 to Indian Patent Application No. 786/KOL/2014 filed on Jul. 22, 2014, the entire content of which is hereby incorporated by reference.

### BACKGROUND OF THE INVENTION

1. Field of the Invention

The invention relates to application and operating system image development and deployment.

2. Description of the Related Art

Cloud-based computing platforms such as Amazon Web Services™ and Microsoft Azure™ are providing great flexibility in deploying applications for users. By being cloud-based the applications are readily available and can also be easily scaled based on demand levels. Such cloud-based applications rely on using previously developed images to allow this scalability. While the cloud systems allow easy scaling, the development of the needed images has not seen similar forward strides. Developing the images is still generally a time intensive effort by skilled developers, even for minor changes to the application.

### SUMMARY OF THE INVENTION

Embodiments according to the present invention provide for highly automated development of cloud-based application image development and deployment. A user can trigger development and deployment of a product using a front-end user interface exposed by the system. Alternatively, a change in an external system such as a code-check-in in a source code version control system can automatically trigger the process. Once the process is triggered, a “build” message is created and queued in a messaging system. This message is accessible to other servers in the cluster. A message queue monitoring system monitors the queue, reads the latest message in the queue and triggers other stages in the build process with a vanilla-image of the product provided by the template serving server and source code to be built provided by the source code revision control server. Multiple servers collaborate and exchange different and multiple messages using the message queue while they trigger and manage each build and deployment stage of the product image. The intermediate files are stored in special file storage servers that can capture and catalog (index) the file along with its metadata. On creation of the product image, a “validate” message is queued in the message-queue. That causes an automated product quality validation system to trigger the validation-process by redeploying and configuring the product image. On completion of the validation, the resultant product-image is be deployed to application servers to allow the user to operate the new application. By utilizing a cluster of pre-configured servers, a completely automated product-image build and deployment system is provided that is able to create and deploy new product images for use in cloud-based applications.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 illustrates a cloud-based system according to the present invention.

FIGS. 2A and 2B illustrate an alternative cloud-based system according to the present invention.

FIGS. 3A-3C are flowcharts of operation of the system of FIG. 1 according to the present invention.

### DETAILED DESCRIPTION OF THE PREFERRED EMBODIMENTS

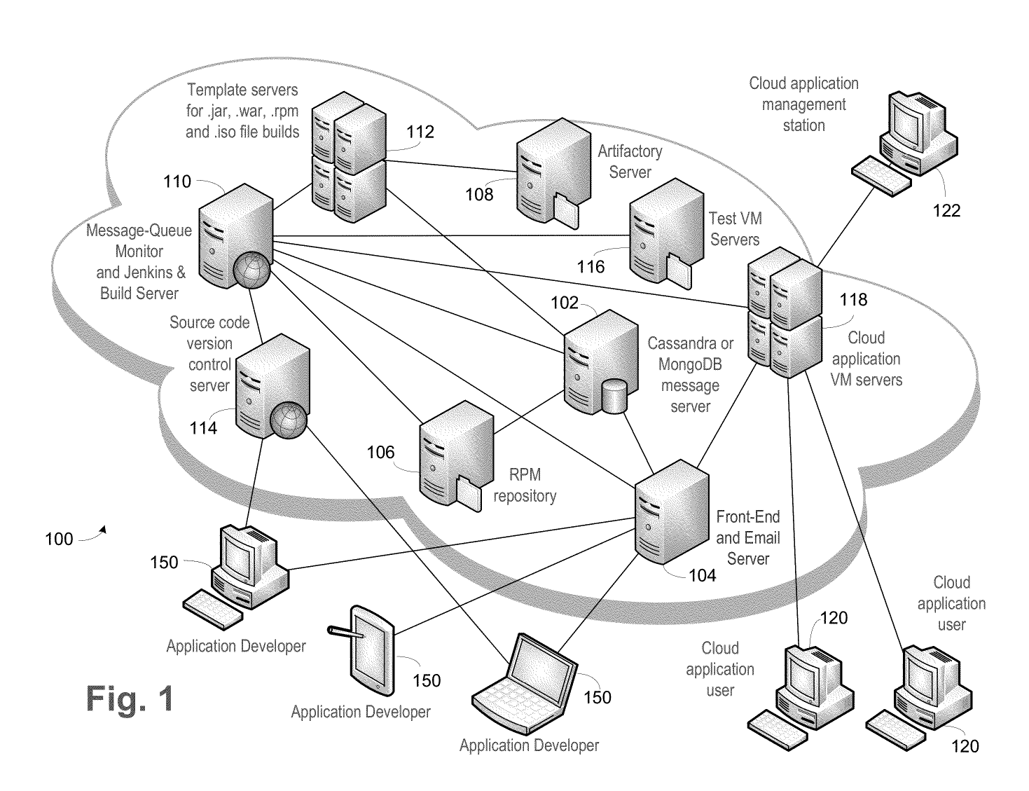

Referring now to FIG. 1, an exemplary cloud-based system 100 is illustrated. The cloud can be a private cloud, such as a VMware cloud using ESXi™ servers connected to a VCenter™, a HyperV™ cloud using Microsoft® Windows Servers connected to a System Center or a public cloud, such as an Amazon AWS-based (Amazon Web Services) infrastructure, RedHat OpenShift™-based infrastructure or Heroku™.

The cloud-based system 100 includes a:

NoSQL database (Apache Cassandra™, MongoDB™, Couchbase™ Server or Redis™) based system 102 to store and mimic a short-message transmission infrastructure where messages (so called “tweets”) can be sent, monitored, read and deleted by machines.

Linux system 104 that exposes a Web GUI front-end interface which can be utilized by users to trigger builds of a product. This system is also responsible for sending emails. The backend used for the web-UI can be a combination of Python Django™ web framework, uWSGI™ build system and Nginx™ HTTP and reverse proxy server, mail proxy server and generic TCP proxy server or a combination of Node.js Express™ web framework and Socket.io™ JavaScript library for real time web applications and Nginx.

Linux system 106 local repository that can sync RPM files from the global repositories periodically. It is also a repository for storing version specific .rpm files generated as part of the build process.

Linux system 108 that is an Artifactory™ server which acts as a repository for storing version specific .jar and .war files generated as part of the build process.

Linux system no to monitor tweets (messages in the message-queue) with specific hashtags and trigger specific operations of specific build stages. It also has Jenkins™ installed in it. Jenkins is an open source continuous integration tool written in Java™. Continuous integration implies that whenever a developer commits code into a source version control system, the continuous integration framework detects the commit and performs a build to confirm that the commit did not break any existing functionality of the product. In one embodiment the Linux system no also includes the necessary packages to perform various compilation and build operations as described below. In other embodiments the compilation and build operations may occur on different servers connected to the message server 102, a template system 112 and other servers as necessary.

Template CentOS™ Linux systems 112 that can individually build .jar, .war, .rpm, and .iso files. These templates are be used to create a virtual machine (VM) dynamically and then perform the required operation (which in this case is a build) and upon completion of the designated operation, the VM is destroyed.

The completed application VMs are deployed to cloud application servers 118 for access by cloud application users 120 and management by a cloud application management station 122.

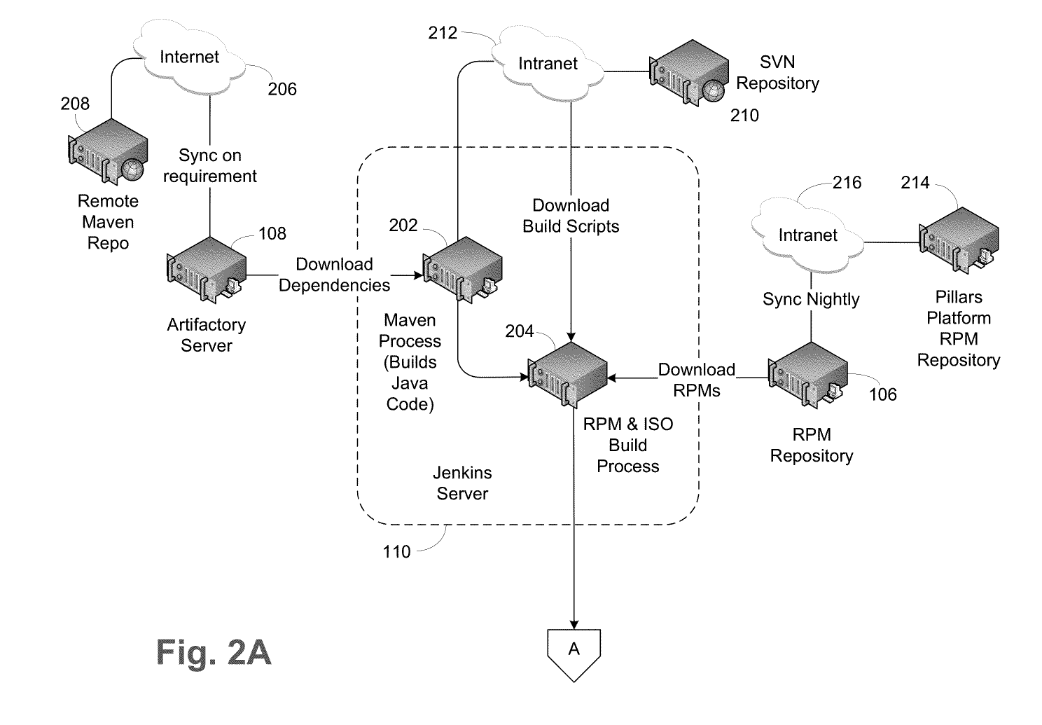

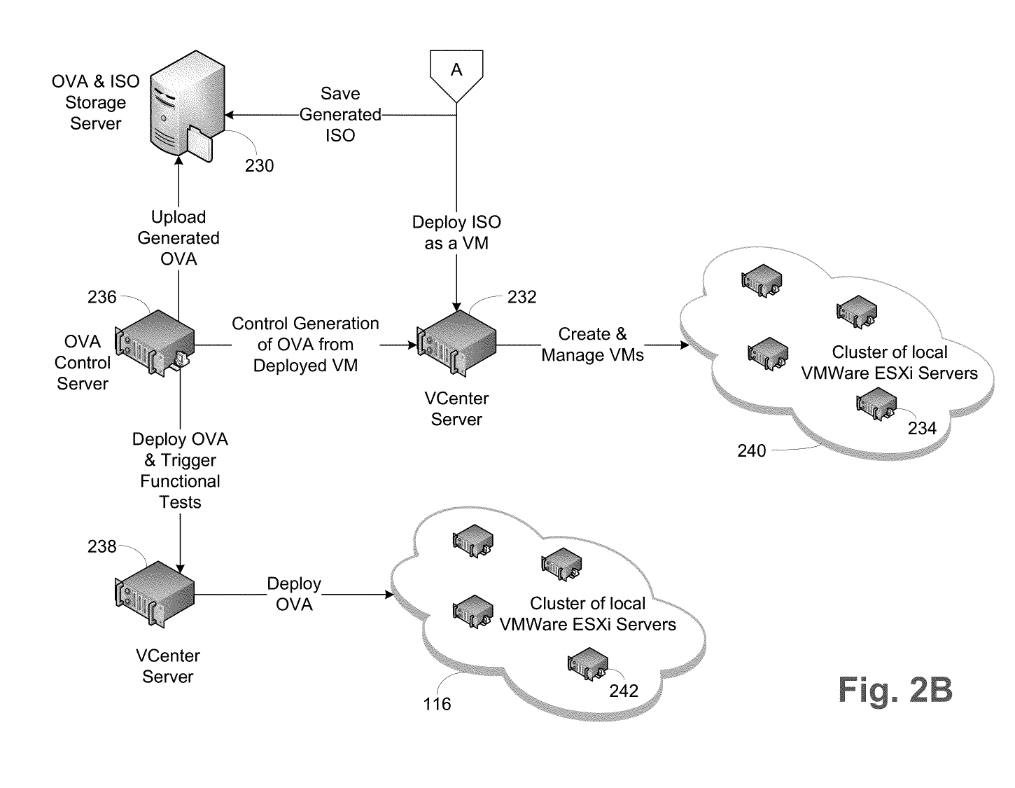

FIG. 2A provides both a different representation of the system 100 and a different embodiment in some aspects. For example, in FIG. 2A the Jenkins server no is illustrated as further including two different servers, an Apache Maven™ server 202 to build Java projects and an RPM and ISO build server 204. It is understood that the Jenkins tool, the Apache Maven build manager and the RPM and ISO build components could be present on a single physical server, either by way of various VMs or simply as operating modules. The Artifactory server 108 is connected to the Maven server 202 and through the Internet 206 to a Maven repository 208. An Apache Subversion™ or SVN version control system repository 210 is connected through an intranet 212 to store build scripts and the like for both the Maven server 202 and the RPM and ISO build server 204. Similarly a Pillars™ platform RPM repository 214 is connected through an intranet 216 to the RPM repository 106 to provide a longer term storage location.

FIG. 2B illustrates an embodiment of the test and cloud application servers. ISO files are provided from the Jenkins server 100 to an OVA and ISO storage server 230 and to a production VCenter server 232. The production VCenter server 232 creates VMs from the ISOs and distributes them to a cluster of ESXi servers 234 which form the application cloud 240. An OVA control server 236 is connected to the production VCenter server 232 and the OVA and ISO storage server 230. The OVA control server 236 communicates with the production VCenter server 232 to develop OVA or Open Virtualization Archive files which can be readily deployed. OVA files are one format of VM files. .vhd and .qcow2 file formats similarly are VM file formats that allow simple deployment of the VM. The OVA files are provided to the OVA and ISO storage server 230 for storage.

The OVA control server 236 is connected to a test VCenter server 238. The test VCenter server 238 deploys the OVA files to a cluster of ESXi servers in a test cloud 244 and then causes the OVAs to execute functional tests to verify proper operation of the application.

In general VMs execute on a hypervisor, which in turn may operate on a host operating system, and include a guest operating system, the necessary binaries and libraries and the desired application. Thus VMs are very complete entities and highly portable and the host and guest operating systems can be different. Containers are much simpler entities, basically just the desired application and necessary binaries and libraries, using the facilities of the host operating system much more directly. Container applications must be developed to use the host operating system, not a different operating system as can be done with VMs. In both cases desired applications are executed as needed, as both VMs and containers can be created and destroyed readily. While this description may use the term VM in explaining the preferred embodiment, it is understand that containers could be used and developed in the same manner, so that references to VMs will also include references to containers.

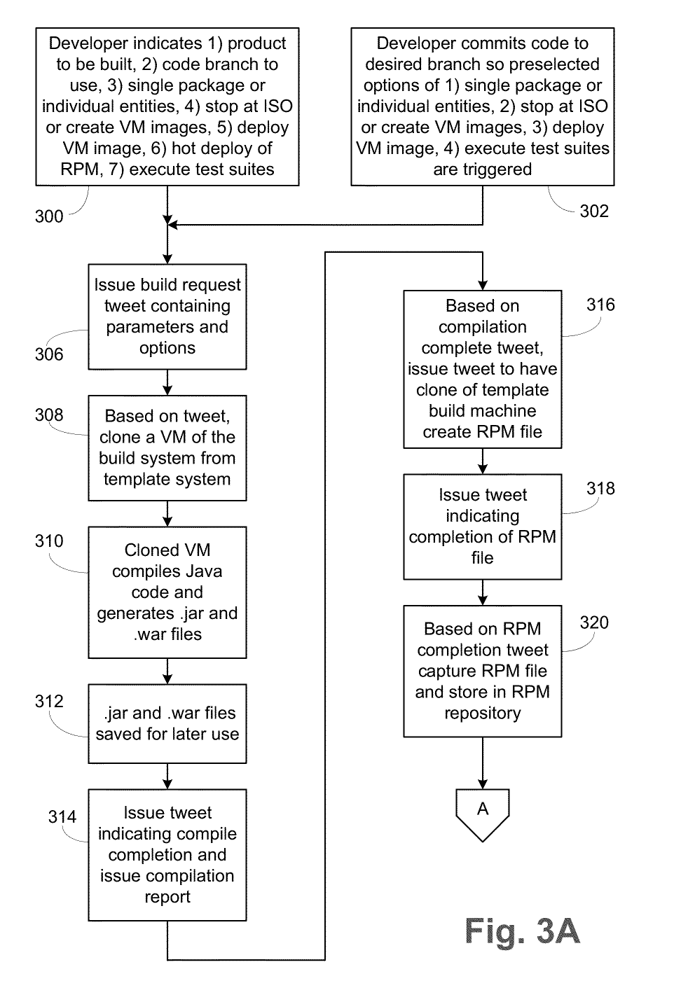

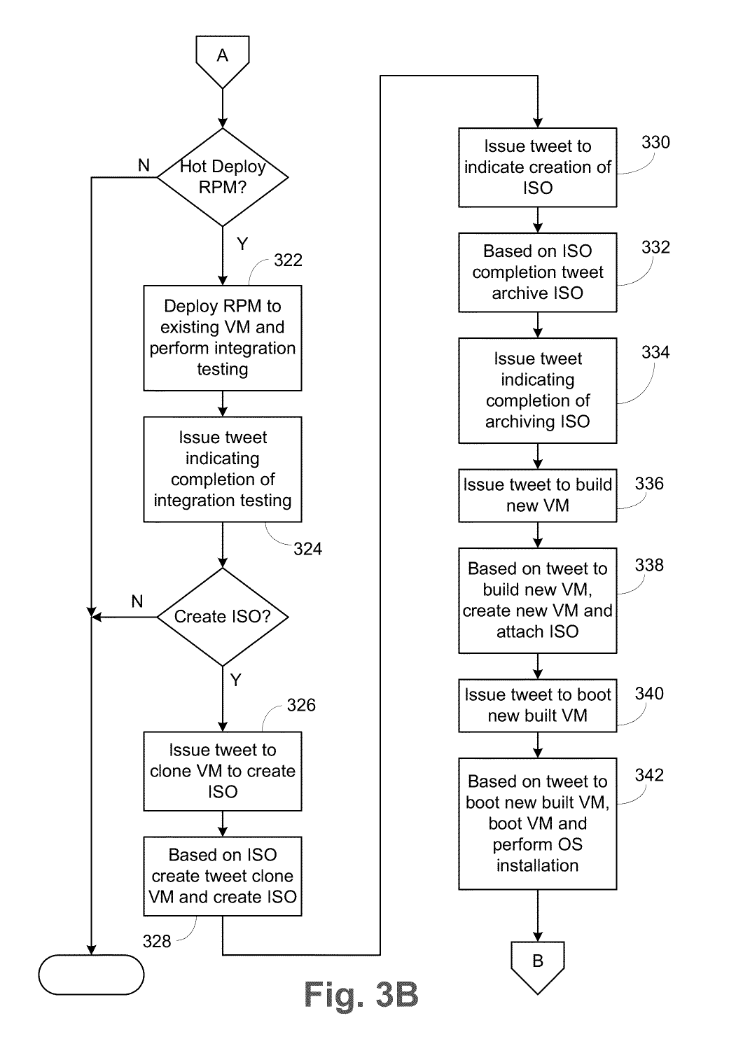

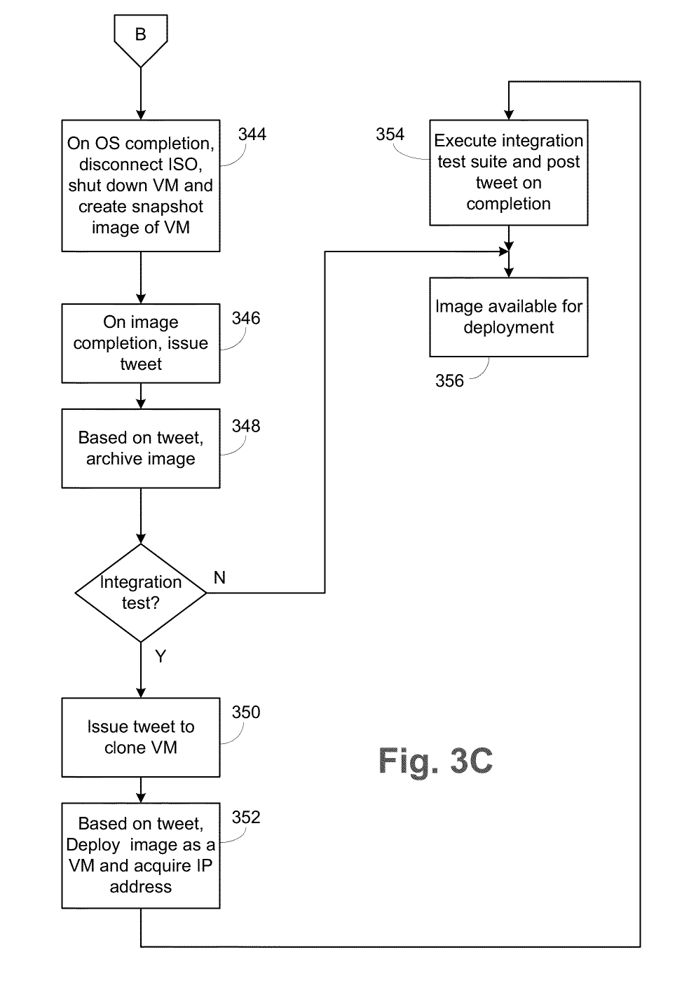

Development of a VM image or container proceeds as follows in a preferred embodiment according to the present invention as illustrated in FIGS. 3A-3C.

A developer 150 pays a visit to the build-portal webpage exposed by the CentOS-based master build machine 104. On the portal at step 300, the developer 150 chooses:

Which products have to be built and which branch of code is to be considered,

Should the products be packaged as a single package or individual entities,

Should the build stop after creating an RPM or ISO file or go all the way and create OVA, .qcow2 or .vhd images.

Should the RPM be hot-deployed to a VM.

Should the build go further and redeploy the resultant .ova or .qcow2 or .vhd image and trigger integration test suits on the deployed image.

On completion of choosing the options, the developer presses “Build” or “Build and Test” as appropriate. In step 306 the front-end-server 104 posts a tweet message which signifies a request to the Jenkins server no to trigger the required build.

Alternatively, in step 302 the product branch can be identified and a build triggered due to a code-commit performed by a developer 150 on a source code version control server 114 coupled to the Jenkins server no. In this case, the build will perform all the steps without providing any facility to stop it at specific stage.

A thread in the Jenkins server no keeps polling for new tweets. When it receives a new one, if the tweet message indicates a build request, in step 308 the Jenkins server no clones a template of the build system from the template system 112 and assigns it the task of compiling the code. A python library is utilized to perform cloning of the VM.

The newly created virtual machine on the Jenkins server no utilizes the Maven™ tool to compile Java code and generate the respective .jar and .war files in step 310. These .jar and .war files are pushed into the Artifactory server 108 in step 312 to be retrieved later. A message is posted on the tweet system indicating completion of the compilation process in step 314. The compilation process also includes a report of the unit-test cases that were executed and their pass/fail status. A message that includes this information is also posted so that anyone listening to this tweet with the specific hashtag can view the report.

The Jenkins server no monitors for tweets, in this case a tweet from a different module on the Jenkins server no, and upon finding out that compilation is done, in step 316 it fires a new tweet requesting a clone of the template CentOS build machine to be used to build an RPM file of the product. A clone is created and the RPM file is built. On a successful build of the RPM file, in step 318 a message is posted as a tweet with relevant hashtag.

The server 106 monitoring the message queue recognizes the new tweet in step 320, captures the RPM file and stores it in the RPM repository 106.

If the developer triggering the build chose hot-deployment of the RPM, then in step 322 the generated RPM is deployed in an existing VM loaded on test VM servers 116 where the product to which the RPM belongs is pre-installed and the integration test is triggered. On completion of this operation, in step 324 a message is posted by the test VM server 116 to the message queue with a specific hashtag with the results.

If the developer chose to continue with ISO creation, in step 326 the Jenkins server no then posts a tweet to clone a VM of the template build machine and trigger the ISO file creation process. The ISO creation server, in one embodiment the Jenkins server no and in other embodiments a separate server, in step 328 recognizes the tweet, creates the ISO file and on completion of the last stage, in step 330 a tweet is posted with a specific hashtag indicating the completion status of the creation of the ISO file.

The ISO creation server listens for the ISO file completion tweet message and if configured to maintain a local archive of the ISO file, in step 332 it archives it in the Artifactory server 108 and in step 334 posts a relevant tweet on the status of the task.

On completion of the ISO stage, in step 336 a tweet is posted to clone a VM of the template build machine to create an ISO. In step 338 an image creation server creates a brand new VM and attaches the ISO file as a virtual CDROM to the new VM. Once the task is accomplished, in step 340 a new tweet requesting boot-up of the VM is fired. In step 342 the VM is booted and the unattended operating system (OS) installation continues. The image creation server waits for the OS installation to complete.

On detecting successful OS installation, in step 344 the image creation server fires a new tweet with relevant hashtag indicating the progress/status of the task. Then the machine disconnects the virtual CDROM from the VM, shuts down the VM gracefully and uses the tools provided by hypervisor to create a snapshot-image of the VM.

In step 346 a tweet is fired with specific hashtag on the progress and status of image creation. In step 348 the image creation server archives the image in the Artifactory server 108 on successful completion. It also computes the checksum on the image and stores it along with the image.

If the developer has chosen to perform an integration test of the product, in step 350 a tweet is posted to clone a VM of the template build machine as an integration test trigger server. The integration test trigger server, such as the OVA control server 236, listens to the tweet and in step 352 redeploys the product image as a VM and waits for the VM to acquire an IP address (if DHCP) or sets a static IP upon detecting a successful boot-up of the VM. In step 354 the integration test server 242 triggers the integration test suite, wait for it to complete and post a tweet on the status along with the results of the test. Anyone (third party app or server) listening to the tweet can look up the report.

If the integration test suite is successful or if not performed, in step 356 the image is then available for deployment as the VMs that form the cloud-based application that is accessible to the users.

It is understood that there could be many more intermediate tweet messages with specific hashtags that could be utilized to perform certain actions.

This build process can further be extended by removing the tweet or short message system and replacing it with an Active Message Queue system like RabbitMQ™.

The messaging system can be completely removed and the Jenkins server no can control the whole process and perform it in an algorithmic fashion—step by step.

It is understood that each indicated server is a computer system which includes a processor for executing instructions and memory for storing those instructions, both during execution and otherwise.

It is understood that a development system according to the present invention can be used to develop application images that are for use in application servers that are not cloud-based as well.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An image development system comprising:
a messaging server for receiving and storing messages and allowing stored messages to be read;
a front end server coupled to said messaging server to receive developer instructions to provide a message to begin an image development process;
a build server coupled to said messaging server for building completed images in a series of operations, each operation including sending a completed message and triggered by a completed message of a prior operation;
an image storage server coupled to said build server and said messaging server to store completed images for deployment; and
an application server coupled to said image storage server to receive a completed image,
wherein said front end server provide messages to said messaging server and said build server provides messages to and reads messages from said messaging server to determine the flow of the image development process.

2. The system of claim 1, further comprising:
a source code version control server coupled to said messaging server and to said build server to provide a message to being an image development process and to provide source code for image development.

3. The system of claim 1, further comprising:
a template server coupled to said build server to store files for use in developing said completed image.

4. The system of claim 1, wherein said build server builds JAR files in a first operation, RPM files in a second operation, ISO files in a third operation and image files in a fourth operation.

5. The system of claim 4, wherein said build server includes a plurality of virtual machines and wherein at least two different files are built on different virtual machines of said build server.

6. The system of claim 1, further comprising:
a test server coupled to said build server and said messaging server to test completed images prior to storage for deployment.

7. The system of claim 1, wherein the completed images contain a virtual machine with an application file.

8. The system of claim 1, wherein the completed images contain containers.

9. An image development method comprising the steps of:
receiving a message containing developer instructions to begin an image development process;
building a completed image in response to the message containing the developer instructions, the building of the image performed as a series of operations, each operation including sending a completed message and triggered by a completed message of a prior operation; and
storing completed images for deployment,
wherein the messages determine the flow of the image development process.

10. The method of claim 9, further comprising the step of:
receiving a message indicating completion of a new source code version to also begin the step of building a completed image.

11. The method of claim 9, wherein the step of building a completed image utilizes templates in developing the completed image.

12. The method of claim 9, wherein the step of building a completed image builds JAR files in a first operation, RPM files in a second operation, ISO files in a third operation and image files in a fourth operation.

13. The method of claim 9, further comprising the step of:
testing completed images prior to storage for deployment.

14. The method of claim 9, wherein the completed images contain a virtual machine with an application file.

15. The method of claim 9, wherein the completed images contain containers.

16. A non-transitory computer-readable medium or media which store a computer program to cause a computer system to perform the following method comprising the steps of:
receiving a message containing developer instructions to begin an image development process;
building a completed image in response to the message containing the developer instructions, the building of the image performed as a series of operations, each operation including sending a completed message and triggered by a completed message of a prior operation; and
storing completed images for deployment,
wherein the messages determine the flow of the image development process.

17. The non-transitory computer-readable medium or media of claim 16, the method further comprising the step of:
receiving a message indicating completion of a new source code version to also begin the step of building a completed image.

18. The non-transitory computer-readable medium or media of claim 16, wherein the step of building a completed image utilizes templates in developing the completed image.

19. The non-transitory computer-readable medium or media of claim 16, wherein the step of building a completed image builds JAR files in a first operation, RPM files in a second operation, ISO files in a third operation and image files in a fourth operation.

20. The non-transitory computer-readable medium or media of claim 16, the method further comprising the step of:
testing completed images prior to storage for deployment.

21. The non-transitory computer-readable medium or media of claim 16, wherein the completed images contain a virtual machine with an application file.

22. The non-transitory computer-readable medium or media of claim 16, wherein the completed images contain containers.
